(19) United States
(12) Patent Application Publication
(10) Pub. No.: US 2007/0063664 A1
(43) Pub. Date: Mar. 22, 2007

(54) Phase identification apparatus having automatic gain control to prevent detector saturation

(75) Inventors: George W. Rhodes, Corrales, NM (US); Gary Kessler, Albuquerque, NM (US); Albert Migliori, Santa Fe, NM (US)

Correspondence Address: SNIDER & ASSOCIATES, P. O. BOX 27613, WASHINGTON, DC, 20038-7613, US

(73) Assignee: AVISTAR, INC., Albuquerque, NM (US)

(21) Appl. No.: 11/522,939

(22) Filed: Sep. 19, 2006

Related U.S. Application Data
(60) Provisional application No. 60/719,209, filed on Sep. 22, 2005.

(51) Int. Cl. H01R 39/46

(52) U.S. Cl. 318/439

(57) ABSTRACT

An apparatus for measuring phase angle difference between two conductors uses a hot stick, a field unit, and reference unit. Voltage is sensed at a conductor, and the voltage is passed through an automatic gain control which adjusts the voltage input to a voltage detector to a level which prevents saturation of the voltage detector. Non-saturation of the voltage detector enables detection of all of the data in a detected sine wave. Pulse width modulation and pulse width modulation RF transmission are used to provide for data transmission from a hot stick to a field unit.

### RELATED APPLICATIONS

This application claims the priority of U.S. provisional application 60/719,209 filed on Sep. 22, 2005, which is incorporated herein by reference.

### BACKGROUND OF THE INVENTION

1. Field of the Invention

This application is in the field of remote phase identification, which is often required in three phase power distribution systems. Remote phase identification is used in balancing loads in power distribution systems and in correctly repairing systems. Remote phase identification is preferable to line tracing to determine which phase is at a given point in a distribution system. More particularly, this invention provides a more accurate measure of phase at a field unit and at a reference unit than any available commercial devices.

It is important to accurately identify each phase of a three-phase power distribution point to enable interconnection and reconnection of power lines when the path from the electrical generating station to the distribution point has passed through regions where it is impossible to physically trace each phase. This situation arises when power lines go underground, pass through transformers, or otherwise pass through regions where inadequate documentation of the connections exist. Noting that the speed of light introduces phase shifts of 1 ms in 300 kilometers, and that at 60 Hz, the phase shift between phases is 5.53 ms, it is critical that any phase measurement be much more accurate that half of that value or 2.76 ms, and have the additional ability to compensate for speed-of-light effects when the comparative reference and field unit are separated by a significant distance.

The apparatus used to determine phase must make electrical connection to both very high and low voltages. In order to extract all of the information from a sine wave, it is necessary to have a complete wave which is not cut off at the top and bottom. This requires a variable gain sensor detector, which can sense widely different line voltages and always produce a sine wave which contains all of the information. This requires a sine wave whose amplitude does not saturate voltage detector circuitry. The simplest connection is to couple through a capacitor to one of the three conductors under test, but any capacitive coupling exhibits much lower impedance to high frequencies than to low frequencies. Thus, systems using this configuration will couple transients and noise much more efficiently than the underlying 60 Hz power line frequency. This results in processing a “noisy” signal to determine the phase. All previous phase identification inventions use the so-called “zero-crossing” of the capacitively coupled noisy signal to determine the phase reference point. Those methods require measuring the absolute time delay between the point being measured and a reference zero-crossing time established at a point on the utility grid where the phase is known. This is usually accomplished using a GPS signal as the time reference. However, a zero crossing reference can provide inaccurate timing due to high-frequency transients and noise that can further cause spurious or multiple zero crossings per cycle. This introduces uncertainty in the zero crossing detection that can lead to incorrect phase identification. The problem arises because only a small portion of the captured noisy signal is used, and, in fact, only the voltages within a few dozen microseconds of the zero crossing are used while the rest of the signal is discarded. It is well known that to extract the maximum useful information from a noisy signal, as much of that signal as possible must be used, averaged, and filtered.

2. Description of the Related Art

Various zero crossing methods of phase identification are known in the art. U.S. Pat. No. 7,031,859, U.S. Pat. Nos. 6,667,610, and 6,642,700 each describe a method of phase identification which relies upon measuring the absolute time delay between the point being measured and a reference zero-crossing time established at a point on the utility grid. In these cases, a GPS signal or another very accurate time is used to provide a time reference for simultaneously measuring a field phase and reference phase.

It has also been known in the art to use phase measurement to determine power line phase. The following publications are examples, however, none of these have a feature of automatic gain control, which assures non-saturation:

Department of Energy WAMS Technology Evaluation and Demonstration, pp. 7-5 through 7-11 and 8-12 and 9-8, Jan. 27, 2001

1993 IEEE International Frequency Control Symposium Precise Timing in Electric Power Systems, Kenneth E. Martin, Bonneville Power Administration, pp. 15-22

IEEE Transactions on Power Delivery, IEEE Standard for Synchrophasers for Power Systems, K. E. Martin, et al., January 1998, Vol. 13, No. 1, pp. 73-77.

Power line phase measurement using Fourier transform techniques is also found in U.S. Pat. No. 6,236,949 to Ronald G. Hart which is for current sensors and which is entitled “Digital Sensor Apparatus and System for Protection, Control and Management of Electricity Distribution Systems.”

### BRIEF SUMMARY OF THE INVENTION

In this invention Applicant in the field unit and reference unit utilizes discrete Fourier transform analysis to compute Fourier transforms of phase values. In order to provide accurate data for the computation of the phase values, it is necessary to capture all of the phase information available in a sine wave, which represents a voltage which has been sensed and detected. The magnitude of the detected sine wave is not important. It is necessary to adjust the voltage to a voltage detector which is a digitizer. If the voltage to the detector is above the saturation level of the circuitry, data will be lost. The loss of data is caused by the cutting off of the top and bottom of a sine wave presented to the voltage detector. In order prevent this condition, the voltage presented to the voltage detector must be reduced to a level where the digitizing circuits are not saturated.

In this invention, a hot stick is used to sense voltage on a power line. The hot stick is a long pole which can be held by a lineman on the ground and which can hold a sensor, detector, and RF transmitter on its end. Power lines, however, vary widely in the voltage present, and it is, therefore, necessary to adjust the voltage to the digitizer on the hot stick in order to prevent saturation no matter what the power line voltage may be. In addition, capacitive coupling varies with the relative humidity, requiring an adaptive circuit to accommodate the variances.

This invention provides an electronics system that can accommodate widely varying signal levels without “saturation” in order to use all the available data contained in a capacitively coupled AC signal. If saturation occurs, the information in the waveform will be lost. To meet this goal, the Applicants have invented a two-stage automatic gain control for the hot stick that uses a microprocessor to switch the gain-determining elements of an adjustable gain amplifier for coarse gain switching, and a fully fed-back integrator and mixer that makes fine, continuous gain changes. This system works as follows:

1. Gain initializes at maximum and a “precision rectifier” circuit rectifies the amplified output. This output is then fed to an integrator that “averages” the rectified signal for a time long compared to the period of the waveform. The resulting DC signal is used to determine whether gain adjustments need to be made. If so, then the gain is switched by a discrete amount by the microprocessor, for example, reduced by a factor of ten. If the precision rectifier signal is now below saturation then further discrete gain switching is terminated by the microprocessor. If the circuits are still saturated, gain is again reduced in this manner.

2. Once the gain is within about a factor of ten of the desired gain, the precision rectifier output voltage is multiplied with the signal voltage via a mixer to provide continuous fed-back gain control. This process is independent of the microprocessor. Gain is adjusted until the precision rectifier signal equals a user-selectable value, indicating correct gain. The response time of this feedback loop is made to be much longer than the period of the waveform.

3. Once the gain is optimum, as detected by the microprocessor, digitization of the amplified signal is initiated. Using a sampling rate of 10 kHz provides adequate over-sampling to ensure accurate reproduction of the 60 Hz component of the waveform. All the previous analog processes for amplification of the signal should be bandwidth limited to the Nyquist frequency of the digitizer. For example, if the digitizer operates at 3.6 kilo-samples/second then all the electronics should have an upper frequency pass band of about 1.8 kHz. By implementing such a pass-band in the analog gain amplifiers, no information is lost at 60 Hz.

4. Transmitting the digitized data from the hot stick transmitter to the main computational package located at the field unit requires care due to the high voltages involved. One method is to use an FM modulated RF link. Most commercially available links of reasonable cost are bandwidth limited to above 20 Hz. This is inadequate because a 22 Hz lower limit will shift the phase measurably at 60 Hz. Therefore, the Applicants have implemented a pulse-width-modulated system whereby digitization of the analog signal is accomplished with a microprocessor that generates a pulse-width-modulated digital signal which is transmitted over a standard RF link, and which is easily reconstructed by the receiver at the field unit.

This invention provides an apparatus for detecting power line AC voltage comprises in combination, a capacitor voltage sensor having an output proportional to a power line voltage, a digitizer voltage detector, an automatic gain control for adjusting voltage input to the voltage detector to a level which prevents saturation of the voltage detector such that all available data in the AC voltage is detected.

The apparatus for detecting power line voltage also comprises a gain control, an adjustable gain amplifier which is connected to said voltage sensor, a rectifier circuit connected to said adjustable gain amplifier which rectifies an output signal of said amplifier, a CPU connected to the output of the rectifier circuit which determines if the rectifier output signal is above saturation, and a CPU that provides a discrete gain adjustment signal to the adjustable gain amplifier when the averaged rectifier output is above a saturation level.

The apparatus further comprises an amplifier which is connected to said voltage sensor, said amplifier having an output, an analog multiplier connected to said amplifier output, a rectifier circuit connected to an output of said analog multiplier and which rectifies an output of said analog multiplier, an integrator connected to an output of the rectifier circuit, wherein the integrator averages the rectifier output signal, and wherein the integrator has an output, a CPU connected to the output of the integrator circuit which determines if the rectifier output signal is above saturation, and a CPU that provides a discrete gain adjustment signal to the adjustable gain amplifier when the integrator output signal is above a saturation level.

The apparatus further comprises an amplifier which is connected to said voltage sensor, said amplifier having an output, a rectifier circuit connected to an output of said analog multiplier and which rectifies an output of said analog multiplier, an integrator connected to an output of the rectifier circuit, wherein the integrator averages the rectifier output signal, and wherein the integrator has an output, wherein the integrator output is connected to an input of the analog multiplier, and wherein the analog multiplier multiplies a voltage from said amplifier by said integrator output and provides an input to said voltage detector.

A system for measuring phase angle difference between two conductors comprises in combination a hot stick having a voltage sensor having an output proportional to a power line voltage, a voltage detector which is a first digitizer for digitizing of the voltage signal, an automatic gain control for adjusting voltage input to the voltage detector to a level which prevents saturation of the voltage detector, wherein prevention of saturation of the voltage detector enables detection of all available phase information contained in the voltage sensor output, a hot stick computer which generates a pulse-width modulated signal, and a radio frequency transmitter for transmitting a pulse-width modulated wave;

A field unit having a radio frequency receiver for receiving said pulse width modulated wave and a converter for generating a sine wave from the pulse width modulated RF wave, a second digitizer having an output for generating a digitized output of the reference voltage, which is initiated by a GPS pulse, and a first computer for computing by a Fourier transform a power line phase value of a fundamental frequency of said reference voltage from the second digitizer output.

A reference unit having a reference voltage sensor, a reference voltage detector which is not saturated by a voltage from the reference voltage sensor, a third digitizer having an output for generating a digitized output of the reference voltage, which is initiated by said GPS pulse, a second computer for computing by a Fourier transform a reference phase value of a fundamental frequency of said reference voltage from the third digitizer output, and a computer for determining a difference between the reference phase value and the power line phase value where the computer is located at the field unit or the reference unit.

### BRIEF DESCRIPTION OF THE DRAWINGS

FIG. 1 shows a gain control circuit wherein an output of a precision rectifier is used to provide a signal to a CPU which provides a discrete gain adjustment signal to an adjustable gain amplifier if the rectifier output is above saturation.

FIG. 2 shows an embodiment where the output of an integrating error amplifier is connected to a CPU which provides a discrete gain adjustment signal to an adjustable gain amplifier when the CPU determines if the rectifier output is above saturation.

FIG. 3 shows an overall block diagram of the circuit components of the hot stick portion of this invention.

FIG. 4 shows an overall block diagram of the components of the field unit portion of this invention.

FIG. 5 shows an overall block diagram of the components of the reference unit of this invention.

FIG. 6 shows an overall block diagram showing the relationship between the hot stick, the field unit, the reference unit and a phase difference value computer.

### DETAILED DESCRIPTION OF THE INVENTION

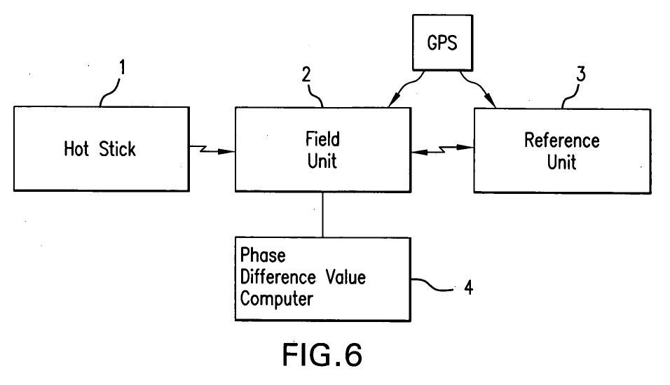

In FIG. 6 there is shown an overall block diagram of the primary units associated with an apparatus and method for remote phase identification of a remote field conductor with respect to a reference unit. A hot stick 1 is used to sense a voltage in a conductor. The hot stick transmits a sine wave to the field unit 2 where the sine wave contains all of the phase angle information. The transmission is a pulse width modulated FM RF modulated link. The inclusion of all phase angle information in the hot stick transmission takes advantage of the fast Fourier transform analysis which occurs in the field unit 2. A reference unit 3 senses voltage at a known location in a power system. Both the field unit 2 and the reference unit 3 receive time signals from a GPS transmitter which allows phase measurements to be made at the same known time. Also shown is a phase difference computer 4. This computer computes the difference between the phase angle at the field unit 2 and the phase angle at the reference unit 3. The phase difference value computer may be located at the field unit 2 or the reference unit 3, depending upon how the system is used. When the phase difference value computer is located at the field unit 2, it enables a field operator (line man) to directly determine which phase in a three-phase power system is being sensed by the hot stick 1.

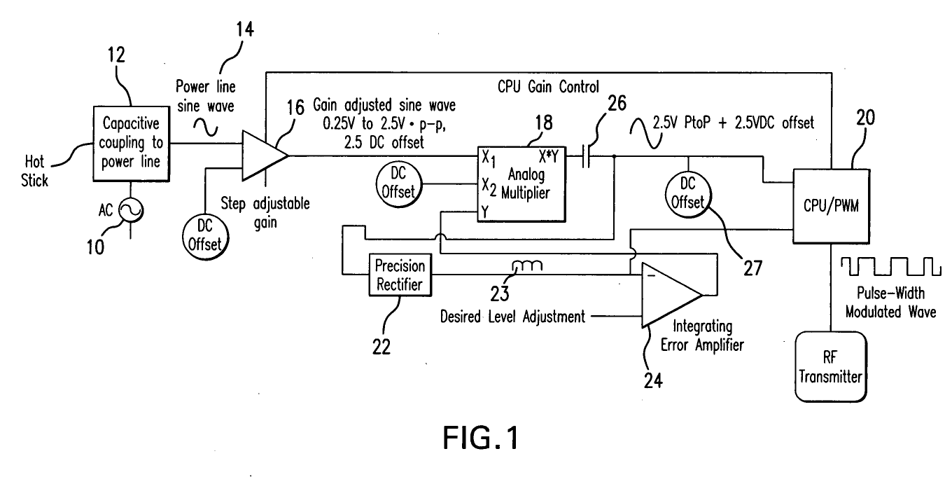

FIG. 1 shows an automatic gain control that is used with the hot stick transmitter unit of this invention. The voltage on power line 10 is sensed by a capacitor or capacitive coupling 12. This produces a power line sine wave output 14 which is connected to an input of a step adjustable gain amplifier 16. Initially, the output of the step adjustable gain amplifier is any value peak to peak with 2.5 volts offset. If the value of the output of amplifier 16 exceeds 2.5 volts peak to peak, then there is a possibility that the circuitry of analog multiplier 18 and the CPU pulse width modulator 20 will be saturated. The CPU/PWM 20 also includes a voltage detector that is a digitizer.

The automatic gain control of this invention includes the step adjustable gain amplifier 16, the analog multiplier 18, a precision rectifier 22, an integrating error amplifier 24, and a blocking capacitor 26. These components operate with the CPU 20 to produce a course discrete gain adjustment loop which includes the step adjustable gain amplifier 16 and the CPU 20.

Next, a fine gain control is provided by a loop which comprises a precision rectifier 22, an integrating error amplifier 24, and the analog multiplier 18.

In FIG. 1 for discrete gain adjustment, an adjustable gain amplifier 12 is connected to the capacitive coupling to the power line 10. The rectifier circuit 22 is connected to an output of the adjustable gain amplifier and then integrated by integrating error amplifier 24 with output going to multiplier 18. This discrete gain adjustment signal is used by the CPU to adjust the gain by factors of the order of 10. The CPU 20 is connected to the output of the rectifier circuit 22 as shown in FIG. 1 and if the CPU determines that the rectified output signal 23 is above saturation, a discrete value is sent to the step adjustable gain amplifier 16 in order to reduce gain. The CPU 20, therefore, provides a discrete gain adjustment to the adjustable gain amplifier 16 when the averaged rectifier output from precision rectifier 22 is above a saturation level.

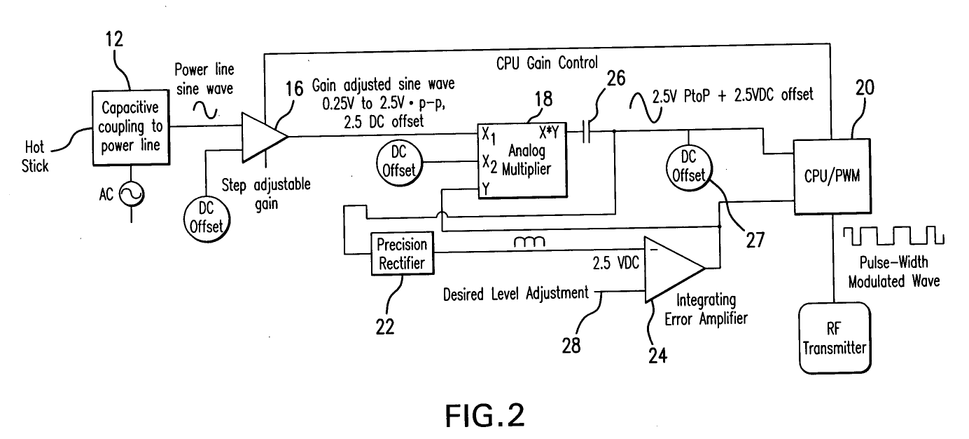

In FIG. 2 there is shown an alternative embodiment for providing discrete gain adjustment when the average rectifier output is above saturation level. The same reference numerals designate the same components as shown in FIG. 1. In FIG. 2, instead of connecting the output of the precision rectifier 22 to the CPU, the output of the integrating amplifier 24 is connected to the CPU. The CPU determines whether there is saturation by sensing the integrating error amplifier 22 output. If this voltage is between the order of 0.2 to 2.5 volts when the saturation level is 3.75 volts, then it is determined that there is no saturation and no discrete gain control will be executed. The CPU 20 provides a discrete gain adjustment signal to the adjustable gain amplifier 16 when the integrator output signal is above a saturation level which is indicated by integrator output voltage in excess of 2.5 volts. Since capacitor 26 blocks DC, DC offset is provided to the input of CPU 20 by the DC offset voltage generator 27.

In both FIGS. 1 and 2, fine gain control is provided for in the same manner. Fine gain control is achieved by an analog multiplier 18 connected to the output of step adjustable gain amplifier 16. In turn, the rectifier circuit 22 is connected to an output of the analog multiplier and rectifies an output of the analog multiplier. The capacitor 26 enables DC offset 27 to offset the level from the analog multiplier so that it is correct for the CPU/PWM 20 and precision rectifier 22. Next, integrator 24 is connected to an output of the rectifier circuit 22 wherein the integrator averages the rectifier 22 output signal. The output of the integrating amplifier is connected to a second input of the analog multiplier 18. The analog multiplier then multiplies a voltage from the amplifier 16 by the integrator 24 output and provides an input to the voltage detector 20. It should be noted that the fine CPU gain control is not controlled by the CPU, but instead is an independent loop. The CPU is used for coarse gain control, but not fine gain control.

As shown in FIGS. 1 and 2, the integrating error amplifier has a desired level adjustment 28. This is a one-time adjustment and is not intended to be performed by an operator in the field. The adjustment sets the level of the output of the integrating error amplifier. Once the user selected value is set, it is not changed.

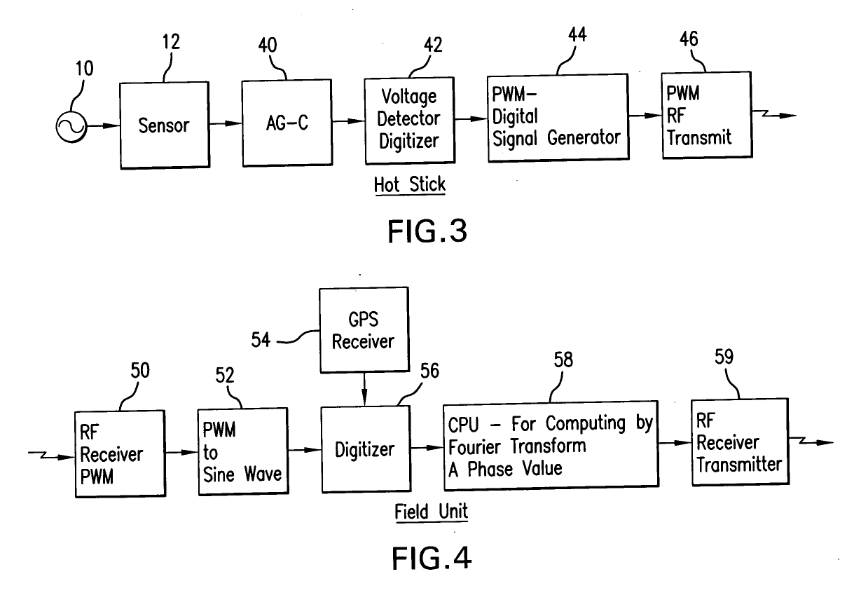

FIG. 3 shows in block diagram form the major components of the hot stick portion of this invention. The power line voltage 10 is detected by a sensor 12 which may be a capacitor. The automatic gain control 40 may be the automatic gain control shown in detail in FIGS. 1 or 2. The purpose of the automatic gain control 40 is to provide a sine wave to the voltage detector 42 which is at a level which will not saturate the voltage detector. The voltage detector 42 is a digitizer under control of a CPU 20. After the voltage has been digitized, the CPU performs a pulse width modulation and provides a digital signal. The digital signal in turn is fed to a pulse width modulation RF transmitter 46 which transmits this signal to the field unit shown in FIG. 4.

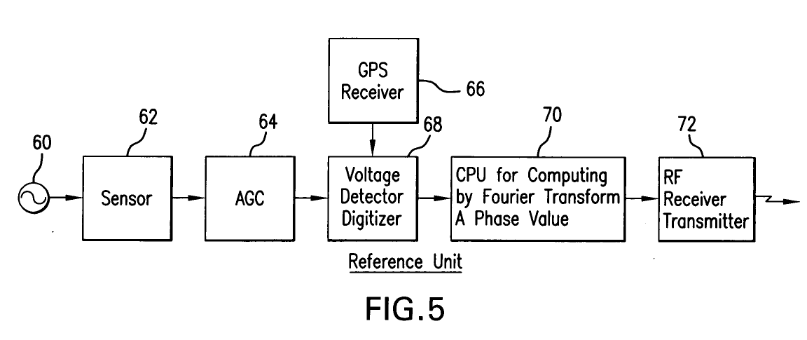

In FIG. 4 there is shown a block diagram arrangement of the field unit. The field unit includes a RF receiver 50 which receives the pulse width modulated RF signal from the transmitter 46. The pulse width modulated signal is then converted to a sine wave at 52 and is digitized at 56. The digitizing at 56 is initiated by a signal which is received from a GPS receiver 54. The GPS initiated signal from digitizer 56 provides for a digitized signal which is then received by CPU 58. CPU 58 then computes, by fast Fourier transform methods, a phase value. The phase value is then stored along with the GPS identifier. The phase value may also be transmitted by an RF receiver transmitter 59. The RF receiver transmitter 59 provides for communication with a reference unit shown in FIG. 5.

FIG. 5 shows the reference unit. The reference unit provides a sensor 62 which senses the voltage at a reference conductor 60. This sensor may also be a capacitor. As shown in FIG. 5, the reference unit may include an AGC 64. However, such an AGC is not necessary in the reference if the voltage 60 is always known and the sensor is compensated by more conventional means such as resistors. A voltage detector 68 receives a sine wave signal from the sensor 60 and provides for digitization in response to a signal from a GPS receiver 66.

It is important that both digitizer 56 and digitizer 68 be initiated at the same time as determined by the GPS clock in order that the Fourier transform calculations begin at the same time. In the reference unit, a CPU is used for computing the Fourier transform of the reference phase value. This occurs at block 70. The reference unit also includes a receiver/transmitter 72.

As shown in FIG. 6, the final step for determining a relationship of one phase with respect to another, or a difference in phase angle is achieved by a computer which determines the difference between phase angles taken from the phase values of the field and the reference phases. This computer 4 may be located in either the field unit or the reference unit. However, it is most common to locate the computer 4 at the field unit, because it is in the field where the information is required in order to properly determine the phases to which field wires are connected.

In this invention, Applicant utilizes an automatic gain control in order to adjust the voltage input to a CPU/digitizer. The voltage to the CPU/digitizer must be less than the saturation voltage of the CPU/digitizer in order for all information in the sine wave to be detected. As is well known in the art, a phase represents voltages in power systems. However, in this invention, the magnitude of the phase is not important. Instead the significant information is the angle of the phase, which represents the phase of the voltage at the point of measurement.

In the field unit, when the sine wave is received from the hot stick, the method to insure utilization of all information is as follows:

1. The received analog signal is digitized by the analysis microcomputer and then digitally multiplied by a synthesized sine wave and a synthesized cosine wave whose absolute phase is determined by synchronization with a time reference such as WWV or GPS clock, and whose frequency is the line frequency, for example 60 Hz in the US. The synchronization is done by mathematical fitting routines that compare Asin(ωt+Φ1), where A is the amplitude, ω is 2πƒ and ƒ frequency is 60 Hz in the USA and 50 Hz in many other locations, t the time reference and Φ₁ the reference phase. The same math is applied at the test point by determining Asin(ωt+Φ₂), where Φ₂ is the phase detected at the test location.

2. The multiplied results are averaged over the course of the measurement interval which might be 10 cycles of 60 Hz.

3. The absolute phase is then simply the arc tangent of the sine-multiplied average divided by the cosine-multiplied average. The result uses all the information, providing an exceptionally accurate value for the absolute phase of only the 60 Hz frequency component in the received signal, and is immune to noise and high-frequency spurious components.

The resulting field unit phase angle is compared by a computer to one similarly obtained at the reference location where the phase is known, and which can be corrected for speed of light effects (if desired) between the reference point and the measurement point. From this, the phase of each of the three transmission lines is now known to accuracy not heretofore possible with zero crossing methods.

The hot stick sensor and electronics and the field unit work together to acquire a bandwidth-limited (this means that high-frequency noise is low-pass filtered out) accurate sine wave from the phase to which the hot stick is connected, transmit it to the field unit and produce a level-shifted sine wave at a receive AC pulse terminal on the field unit board Receiver analog Pulse RAP.

1. The analog pulse at the hot stick main board is a sine wave of approximately 2.5V peak-to-peak amplitude, level shifted so that it has a DC component of 2.5V as shown in FIGS. 1 and 2. Thus the peak of the sine wave is at about 3.75V and the valley is at 1.25V. The hot stick main-board CPU must be able to recognize the presence of this sign wave. The received sine wave is multiplied with a sine and cosine wave of unit amplitude, generated in software by the CPU. Because the frequency of the AC grid varies by of order 1% over short times (a few minutes), only a few cycles (such as 10) of the RAP should be used. The hot stick transmits the sine wave information to the field unit using pulse width modulation.

In the hot stick there may be an indicator light block (LED) and an auto-shutdown block (ASB) as well. The pulse width modulation (PWM) frequency is set to 5 kHz in software.

2. In addition to the RAP hot stick signal, the receiver located at the field unit generates a Receiver Analog Strength signal that indicates signal strength. Because the RAP signal will look like hash or be zero if no good sine wave is sent, and because the hot stick will not transmit until a good sine wave is present, it is not necessary to use this signal.

Operation of Hot Stick AGC

1. The phase voltage from the capacitor coupling to the power line is divided by the hotstick itself down to manageable but unknown levels and processed by the AGC block 40. The amplitude of the sine wave is converted to a 0-3.5Vdc signal automatic gain control voltage (AGCV) by the precision rectifier and is also fed to a very-slow-response closed-loop continuously-variable integrating error amplifier 24 gain control that is in turn connected to the analog multiplier 18. No programming is required for this—the fine gain control is closed loop. AGCV is the rectified amplitude of the actual final sine wave to be sent to the transmitter and must be near 2.5V for a properly acquired sine wave and the control CPU 20 tests for this. After about 4 seconds, AGCV will stabilize.

a) If AGCV is above about 2.5 volts, then the sine wave to be digitized is too high and must be decreased. If AGCV is below 2.5 volt it is too low.

b) The first gain stage provides step-control of gain by control from CPU 20 to amplifier 16. It will take about 4 seconds for AGCV to stabilize. This stage will provide about a factor of 100 change in gain, while the fine gain AGC block is good for another factor of 10 or so and is not under programming control.

c) When AGCV is 2.5V, correct gain has been achieved. If this cannot be achieved, then no useful sine wave is present. On correct AGCV detection the control CPU 20 will indicate that the PWM can be started and can enable the transmitter.

d) A possible mode is to enable the transmitter hot stick right away. If the PWM is not yet running, this transmits a dc voltage to the receiver. Thus, instead of hash, a stable voltage is present, easily detected by the main board CPU at the field unit as an incorrect signal.

This way, Applicants can use a signature of the received signal (a sine wave is transmitted only if EVERYTHING is ok) for the main board to know it has a good sine wave.

a) The hot stick control CPU detects some sort of idle state (no sine wave for 10 minutes) and disconnects all power from the system, shutting it down.

b) A manual push of a switch for (one second) will do a hard restart.

1. An apparatus for detecting power line AC voltage comprising in combination:
a voltage sensor having an output proportional to a power line voltage;
a voltage detector;
an automatic gain control for adjusting voltage input to the voltage detector to a level which prevents saturation of the voltage detector;
wherein all available data in the AC voltage is detected.

2. The apparatus for detecting power line phase in accordance with claim 1 wherein the sensor is a capacitor.

3. The apparatus for detecting power line voltage in accordance with claim 1 wherein prevention of saturation of the voltage detector enables detection of available phase information contained in the voltage sensor output.

4. The apparatus for detecting power line voltage in accordance with claim 1 wherein the gain control comprises:
an adjustable gain amplifier which is connected to said voltage sensor;
a rectifier circuit connected to an said adjustable gain amplifier which rectifies an output signal of said amplifier;
a CPU connected to the output of the rectifier circuit FIG. 1 which determines if the rectifier output signal is above saturation;
wherein the CPU provides a discrete gain adjustment signal to the adjustable gain amplifier when the averaged rectifier output is above a saturation level.

5. The apparatus for detecting power line voltage in accordance with claim 1 wherein the gain control comprises:
an amplifier which is connected to said voltage sensor, said amplifier having an output;
a analog multiplier connected to said amplifier output;
a rectifier circuit connected to an output of said analog multiplier and which rectifies an output of said analog multiplier;
an integrator connected to an output of the rectifier circuit, wherein the integrator averages the rectifier output signal, and wherein the integrator has an output;
a CPU connected to the output of the integrator circuit which determines if the rectifier output signal is above saturation;
wherein the CPU provides a discrete gain adjustment signal to the adjustable gain amplifier when the integrator output signal is above a saturation level.

6. The apparatus for detecting power line voltage in accordance with claim 1 wherein the gain control comprises:
an amplifier which is connected to said voltage sensor, said amplifier having an output;
a analog multiplier connected to said amplifier output;
a rectifier circuit connected to an output of said analog multiplier and which rectifies an output of said analog multiplier;
an integrator connected to an output of the rectifier circuit, wherein the integrator averages the rectifier output signal, and wherein the integrator has an output;
wherein the integrator output is connected to an input of the analog multiplier; and
wherein the analog multiplier multiplies a voltage from said amplifier by said integrator output and provides an input to said voltage detector.

7. The apparatus for detecting power line voltage in accordance with claim 5 wherein the gain control further comprises:
a desired level adjustment which is adjusted until the rectifier signal reaches a user selectable value.

8. The apparatus for detecting power line phase in accordance with claim 7 wherein the user selectable value is set with an integrating error amplifier level adjustment control.

9. The apparatus for detecting power line phase in accordance with claim 3 wherein the voltage detector is a digitizer for digitizing of the voltage signal.

10. The apparatus for detecting power line voltage in accordance with claim 9 further comprising a CPU which generates a pulse-width modulated digital signal.

11. The apparatus for detecting power line voltage in accordance with claim 10 further comprising a radio frequency transmitter for transmitting the pulse-width modulated digital signal as a pulse width modulated wave.

12. The apparatus for detecting power line voltage in accordance with claim 10 further comprising a radio frequency receiver for receiving said pulse width modulated wave and a converter for generating a sine wave from the pulse width modulated digital signal.

13. The apparatus for detecting power line voltage in accordance with claim 12 wherein the radio frequency transmitter is located in or on an end of a hot stick.

14. The apparatus for detecting power line voltage in accordance with claim 12 wherein the radio frequency receiver is located at a phase angle difference measurement field unit.

15. An apparatus for measuring phase angle difference between two conductors comprising in combination:
a hot stick having
a voltage sensor having an output proportional to a power line voltage;
a voltage detector which is a first digitizer for digitizing of the voltage signal;
an automatic gain control for adjusting voltage input to the voltage detector to a level which prevents saturation of the voltage detector;
wherein prevention of saturation of the voltage detector enables detection of all available phase angle data contained in the voltage sensor output;
a hot stick computer which generates a pulse-width modulated signal; and
a radio frequency transmitter for transmitting a pulse-width modulated wave;
a field unit having
a radio frequency receiver for receiving said pulse width modulated wave and a converter for generating a sine wave from the pulse width modulated RF wave;
a second digitizer having an output for generating a digitized output of the reference voltage, which is initiated by a GPS pulse; and
a first computer for computing by a Fourier transform a power line phase value of a fundamental frequency of said reference voltage from the second digitizer output;
a reference unit having
a reference voltage sensor;
a reference voltage detector which is not saturated by a voltage from the reference voltage sensor;
a third digitizer having an output for generating a digitized output of the reference voltage, which is initiated by said GPS pulse; and
a second computer for computing by a Fourier transform a reference phase value of a fundamental frequency of said reference voltage from the third digitizer output;
a computer for determining a difference between the reference phase value and the power line phase value wherein the computer is located at the field unit or the reference unit.

16. An apparatus for measuring phase angle difference between two conductors in accordance with claim 1 wherein the computer for determining a difference is located in the field unit.

17. A method for measuring phase angle difference between two conductors comprising in combination:
placing hot stick voltage sensor having an output proportional to a power line voltage adjacent to a power line;
automatically controlling gain and adjusting input to a voltage detector to a level which prevents saturation;
digitizing the input to the voltage detector with a voltage digitizer;
wherein prevention of saturation of the voltage digitizer enables detection of available phase information contained in the voltage sensor output;
generating a pulse-width modulated signal;
transmitting the pulse width modulated signal as pulse width modulated RF wave;
placing field unit where it receives the transmitted pulse width modulated RF wave;
receiving said pulse width modulated RF wave and a converting the pulse width modulated wave to a sine wave signal;
generating a digitized output of the power line voltage, which is initiated by a GPS pulse;
computing by a Fourier transform a power line phase value of a fundamental frequency of said power line voltage from the second digitizer output;
placing a reference unit at a grid known location;
sensing a reference voltage;
generating a digitized output of the reference voltage, which is initiated by said GPS pulse;
computing by a Fourier transform a reference phase value of a fundamental frequency of said reference voltage from the third digitizer output;
determining a difference between the reference phase value and the power line phase value.

18. The apparatus for measuring phase angle difference in accordance with claim 15 wherein the automatic gain control is a two stage automatic gain control which comprises:
a first discrete automatic gain control stage comprising:
a rectifier which rectifies an input to the voltage detector to provide an automatic gain controlled DC voltage output;
a CPU which receives the DC voltage from the precision rectifier and which determines whether gain adjustments need to be made;
wherein a step adjustable input amplifier gain is changed by the CPU by a discrete amount when gain adjustment is needed; wherein when it is determined that the rectifier output DC voltage signal is below saturation discrete gain changing is terminated by the CPU;
a second fine automatic gain control stage comprising:
the precision rectifier which rectifies the input to the voltage detector;
an integrator connected to said rectifier which averages the gain controlled DC voltage signal of the rectifier for a long time compared to the period of the power line to produce a resulting DC signal; and
a multiplier for multiplying the signal voltage by an integrator output voltage to provide a continuous feedback for fine gain control.

19. The apparatus for measuring phase angle difference in accordance with claim 15 wherein the automatic gain control is a two stage automatic gain control which comprises:
a first discrete automatic gain control stage comprising:
a rectifier which rectifies an input to the voltage detector to provide an automatic gain controlled DC voltage;
an integrator connected to said rectifier which averages the gain controlled DC voltage signal of the rectifier for a long time compared to the period of the power line to produce a resulting DC signal;
a CPU which receives the DC voltage from the integrator and which determines whether gain adjustments need to be made;
wherein a step adjustable gain amplifier is changed by the CPU by a discrete amount when gain adjustment is needed; wherein when it is determined that the rectifier output DC voltage signal is below saturation discrete gain changing is terminated by the CPU;
a second fine automatic gain control stage comprising:
the precision rectifier which rectifies the input to the voltage detector;
the integrator connected to said rectifier which averages the gain controlled DC voltage signal of the rectifier; and
a multiplier for multiplying the signal voltage by an integrator output voltage to provide a continuous feedback for fine gain control.
